(19) United States
(12) Patent Application Publication
(10) Pub. No.: US 2009/0072527 A1
(43) Pub. Date: Mar. 19, 2009

(54) HOLOGRAPHIC IN-MOLD LABEL

(75) Inventors: Donald P. Klein, Dell Rapids, SD (US); Robert E. Baum, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL, INC., Sioux Falls, SD (US)

(21) Appl. No.: 11/856,292

(22) Filed: Sep. 17, 2007

(51) Int. Cl. B42D 15/00; B29C 43/00; B42D 15/10

(52) U.S. Cl. 283/107; 264/509; 283/81

(57) ABSTRACT

The specification discloses an in-mold label (IML) having an improved holographic image. The label includes a base ply and a top ply laminated together. The base ply is an in-mold label material, and the top decorative ply is a different material that is smoother than the base ply material. A holographic material is on the top surface of the top ply, and a holographic image in formed in the holographic material to provide a bright, aesthetically attractive label.

### BACKGROUND OF THE INVENTION

The present invention relates to in-mold labels, and more particularly to in-mold labels having holographic images.

In-mold labels (IMLs) and labeling are well known. Such labels are adhered to an article, such as a bottle, during the molding of the article. The label is placed within the cavity of a mold before molding, and the label adheres to the surface of the article during molding.

A typical application of in-mold labeling is in the production of blow-molded containers. A pre-printed label with heat-activated adhesive is placed against the surface of the mold cavity and held in position by vacuum ports and/or static electricity. The mold is closed, and a plastic container blank is heated and inflated within the mold. The hot plastic presses against the label, activating the adhesive and causing the label to adhere to the outer surface of the newly molded container. The mold is opened, and the labeled container is ejected from the mold. Examples are disclosed in U.S. Pat. No. 5,344,305 issued Sep. 6, 1994 entitled “Apparatus for In-Mold Labeling”; and U.S. patent application Ser. No. 11/384,578 filed Mar. 20, 2006 entitled “Laminated Multi-Ply In-Mold Label.”

In-mold labels offer a wide variety of printing, graphic, and other visual treatments. One such treatment is the inclusion of holographic images. Such images require reflective metallized portions created by printing the labels with metallic ink or otherwise depositing metal layers on the label. The quality of the reflective ink or layer depends in part on the relative roughness or smoothness of the material on which the layer is created. Unfortunately, IML materials are relatively rough, and consequently, the quality of the reflective layers and the holographic images have been less than desired.

### SUMMARY OF THE INVENTION

The aforementioned problems are overcome by the present invention in which a holographic material is formed on a relatively smooth ply that is laminated to a relatively rough base ply. The holographic material can be metallized ink, deposited metal, or any other suitable material. In the disclosed embodiment, the base ply is a known IML material.

The present invention provides a holographic material of extremely high quality on an in-mold label. Consequently, the label provides improved aesthetics over known labels.

These and other objects, advantages, and features of the invention will be more fully understood and appreciated by reference to the description of the current embodiment and the drawings.

### BRIEF DESCRIPTION OF THE DRAWINGS

FIG. 1 is a perspective view of the holographic in-mold label of the present invention in-molded onto a container; and

FIG. 2 is a perspective, sectional view of the label.

### DESCRIPTION OF THE CURRENT EMBODIMENT

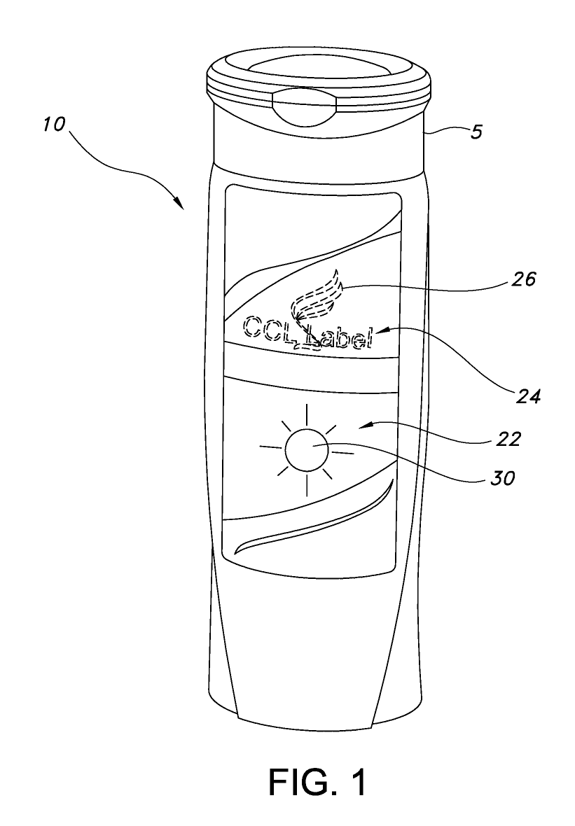

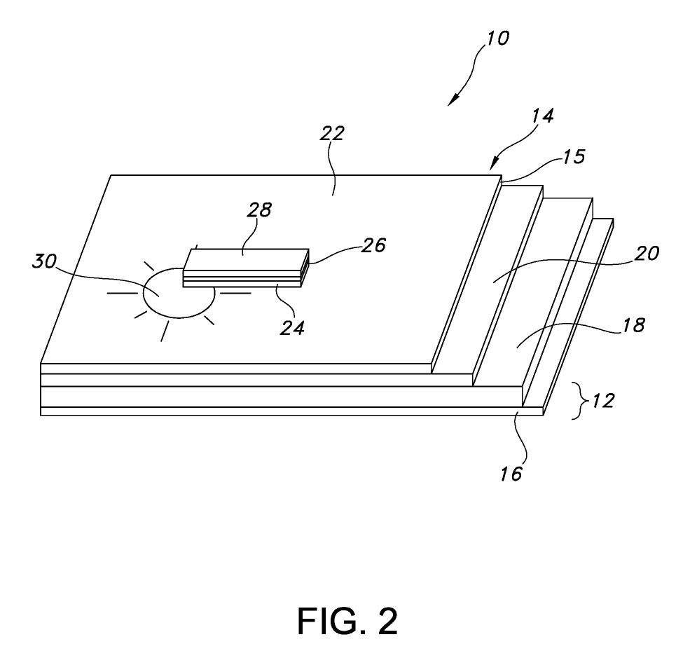

One embodiment of the in-mold label (IML) of the present invention is illustrated in FIGS. 1-2 and generally designated 10. The label 10 is applied to an article 5 and includes a base ply 12 and a decorative or top ply 14. A metallized layer or other holographic material 22 is carried by the decorative ply. The label can include additional coatings and printing as will be described to further enhance its aesthetics.

### I. In-Mold Label

The current embodiment is a laminated two-ply IML. However, the laminated IML may include additional or different plies. For example, a person skilled in the art could extend the described embodiment to an IML having three or more plies. The disclosed is rectangular, but the label could be virtually any shape in view of aesthetic and functional considerations.

a. Base Ply

The base ply 12 generally includes a base layer 18, an adhesive 16 on the lower surface of the base layer 18, and an adhesive 20 on the upper surface of the base layer 18. The current base layer is a plastic film, and specifically is a polyolefin. The surface roughness of this material is medium roughness. Alternatively, the base layer 18 may be constructed of other IML materials or other suitable material known to those skilled in the art. Such materials include without limitation polyolefins, polypropylenes, and polyethylenes.

The adhesive layer 16 is applied to the lower surface of the base layer 18 in any suitable technique or pattern known to those skilled in the art. In the current embodiment, the adhesive layer 16 is responsive to, or activated by, heat. Alternatively, the adhesive layer 16 may be other IML adhesives or other suitable adhesives capable of being activated during the molding process. The current base layer 18 with the adhesive 16 pre-applied is sold by YUPO under the designation ISE 105.

The adhesive layer 20 is applied to the upper surface of the base layer 18 in any suitable technique and pattern known to those skilled in the art. In the current embodiment, the adhesive layer 20 is a laminating adhesive such as solvent gravure (e.g. using alcohol and acetate), moisture cured, 100% solids gravure, and/or UV-cured laminating adhesives. Alternatively, the adhesive layer 20 may be any other suitable laminating adhesive. Although the adhesive layer 20 in the current embodiment is associated with the base ply, in alternative embodiments the adhesive layer 20 may be part of the top ply 14.

The adhesive layer 20 “slaves” the top ply 14 to the base ply 12. Consequently, the top ply 14 will shrink at the same rate (i.e. will follow) the base ply 12 when subjected to the temperatures associated with the molding of the article 5.

b. Decorative Ply

The decorative or top ply 14 generally includes a top film 15 and a metallized layer or other holographic material 22 on the upper surface of the film. The top ply 14 is similar in shape and size to the base ply 12. Alternatively, the top ply 14 may be shaped differently and constructed of other suitable materials. The top ply 14 overlies the base ply 12 uniformly and closely to provide a unified/unitary appearance. In the current embodiment, the top film 15 is clear or transparent. The film 15 alternatively may be translucent or even opaque depending on the desired appearance.

The current film 15 is a plastic film, and specifically is a 0.8 mil polypropylene sold by ITW under the designation BOPP80 Pattern 081. The surface roughness of this material is very smooth. Alternatively, the film 15 may be constructed of other suitable material known to those skilled in the art. Such materials include without limitation polyester, polyvinylchloride, and polypropylene. The important feature of the present invention is that the top ply has a smoother surface (i.e. a lower surface roughness) than the base ply 12.

The current metallized layer or holographic material 22 is created by vacuum metal deposition on the film 15. Alternatively, the holographic material 22 could be a metallized ink or any other material providing relatively high reflectivity and suitable for the formation of a holographic image.

The holographic material 22 is on the upper surface of the film 15 to provide maximum reflectivity and holographic effect. Alternatively, the holographic material 22 could be printed on the undersurface of the top ply.

A holographic image 30 (FIG. 1) is formed in the holographic material 22 using any suitable technique known to those skilled in the art. The formation of the holographic image 30 on the upper surface of the film 15 provides enhanced visual quality and impact.

Additional layers may be printed or otherwise applied over the holographic material 22. Specifically in the current embodiment, a clear primer 24, such as a water-based primer, is printed directly over the holographic material 22. The primer 24 protects the holographic material 22 and provides a surface on which additional printed layers will better adhere.

Additional printing may be included. For example, the current embodiment includes printed layers 26 and 28 over the primer 24. Alternatively, printing may be included on the lower surface of the decorative ply 14 and/or on the upper or lower surface of the base ply 12. White or other printing may be used to alter the opacity and/or to hide printing on the lower surface of the top ply 14.

### II. Application and Use of the IML

In operation, pre-printed and adhesive-coated labels 10 are provided in roll, magazine, or other suitable form (not shown) as known in the art. The labels 10 may be transferred to the interior of a blow mold or an injection mold (not shown) using techniques known in the art. Known molding techniques may be used to form the container and thereby adhere the IML 10 to the molded article 5. Specifically, the IML 10 may be placed into a mold with adhesive 16 facing away from the mold. The adhesive 16 is activated by the molding process, causing the molding 10 to adhere to the article 5. After the molded article has “frozen” or is cured, the molded article 5 with the adhered two-ply label 10 may be removed from the mold. In essence, the IML 10 becomes part of the molded article 5 during the molding process.

In use, the IML 10 provides a holographic image on its top surface and optionally includes additional printing on any of the combined four surfaces of the base ply 12 and the top ply 14. The holographic material is of improved quality primarily because the of surface smoothness of the top ply 14. And therefore the holographic image is of improved quality.

The above description is that of the current embodiment of the invention. Various alterations and changes can be made without departing from the spirit and broader aspects of the invention as defined in the appended claims, which are to be interpreted in accordance with the principles of patent law, including the doctrine of equivalents.

The embodiments of the invention in which an exclusive property or privilege is claimed are defined as follows:

1. A holographic in-mold label comprising:
a base ply having upper and lower surfaces having a first smoothness;
a top ply having upper and lower surfaces having a second smoothness, said second smoothness being smoother than said first smoothness, said lower surface of said top ply facing said upper surface of said base ply; and
a holographic material on said top ply.

2. The in-mold label of claim 1 further comprising an adhesive adhering said upper surface of said base ply and said lower surface of said top ply, said adhesive providing a sufficient bond so that the two plies deform together in response to in-mold temperatures.

3. The in-mold label of claim 1 further comprising an in-mold process activated adhesive on the lower surface of said base ply.

5. The in-mold label of claim 2 wherein said adhesive comprises a solvent gravure.

6. The in-mold label of claim 1 wherein said holographic material is micro-embossed metallized layer.

7. The in-mold label of claim 1 further comprising a transparent protective coating over said holographic material.

8. An in-mold label comprising:
a holographic ply having a surface roughness and including a holographic image; and
a base ply secured to said holographic ply, said base ply having a surface roughness greater than said holographic ply surface roughness, said base ply including a temperature activated adhesive.

9. The in-mold label of claim 8 further comprising printing on said holographic ply.

10. The in-mold label of claim 8 wherein said holographic ply is bonded to said base ply with sufficient strength to cause said plies to deform together in response to in-mold temperatures.

11. The in-mold label of claim 8 wherein said holographic image is micro-embossed.

12. The in-mold label of claim 8 wherein said holographic ply includes a top surface facing away from said base ply, said holographic image being on said top surface.

13. The in-mold label of claim 12 further comprising a protective layer over said holographic image.

14. A method for molding an article having a holographic image on a label comprising the steps of:
providing a label having a base ply and an image ply bonded together so that they must deform at the same rate in response to in-mold temperatures, the image ply having a smoother surface than the base ply, the image ply including a holographic image, the base ply including a temperature activated adhesive;
placing the label into a mold with the image ply facing the mold;
molding the article in the mold thereby activating the adhesive to adhere the label to the article; and
removing the molded article with the adhered label from the mold.

15. The method of claim 14 wherein said molding step comprises blow molding.

16. The method of claim 14 wherein said molding step comprises injection molding.
